(19) United States
(12) Patent Application Publication
(10) Pub. No.: US 2026/0084440 A1
(43) Pub. Date: Mar. 26, 2026

(54) PRINTING SYSTEM, METHOD OF DYEING MEDIUM, AND INK SET

(71) Applicant: MIMAKI ENGINEERING CO., LTD., Nagano (JP)

(72) Inventors: Junki Ito, Nagano (JP); Takeyuki Sakurai, Nagano (JP); Akihiro Nishiguchi, Nagano (JP)

(73) Assignee: MIMAKI ENGINEERING CO., LTD., Nagano (JP)

(21) Appl. No.: 19/324,157

(22) Filed: Sep. 10, 2025

(30) Foreign Application Priority Data
Sep. 20, 2024 (JP) 2024-163784

(51) Int. Cl. B41J 11/00; B41J 2/21; B41J 3/407

(52) U.S. Cl. CPC B41J 11/00242; B41J 2/2107; B41J 3/4078

(57) ABSTRACT

A printing system includes a controller that controls printing by a printing apparatus and textile printing processing by a heat treatment apparatus. The controller includes a print data generation unit, a print control unit that prints information on a medium based on the print data, and a textile printing parameter setting unit that sets at least a heating temperature and a heating time of the medium in the processing. Each of the inks included in an ink set contains a sublimable dye as a color development component, and the dye contained in a magenta ink is a disperse red. The textile printing parameter setting unit sets a heating temperature in the processing to a first temperature higher than a heating temperature and sets a heating time in the processing to a first time longer than a heating time when the dye contained in the magenta ink is a disperse red.

### CROSS REFERENCE TO RELATED APPLICATIONS

This application claims the priority benefit of Japanese Patent Application No. 2024-163784, filed on Sep. 20, 2024. The entirety of the above-mentioned patent application is hereby incorporated by reference herein and made a part of this specification.

### TECHNICAL FIELD

The present disclosure relates to a printing system, a method of dyeing a medium, and an ink set.

### DESCRIPTION OF THE BACKGROUND ART

As one aspect of textile printing, there is a transfer-type textile printing method using a sublimation dye. This textile printing method is performed by the following procedure. (I) Print information on a transfer medium. (II) The transfer medium on which information is printed is brought into contact with a printing target object such as a fabric. (III) The sublimation-typed dye is sublimated by heating and pressurizing the transfer medium and the printing target object in a state where the transfer medium and the printing target object are in contact with each other, and the information printed on the transfer medium is transferred to the printing target object.

In addition, there is a direct type textile printing method of performing direct printing on a medium (printing target object) using a sublimation-typed dye. This textile printing method is performed by the following procedure. (I) Print information on a medium. (II) The printed information is fixed to the medium by heat treatment of the medium on which the information is printed.

Japanese Unexamined Patent Publication No. 2013-231683 and Japanese Unexamined Patent Publication No. 2015-071385 disclose ink sets for sublimation transfer used for transfer type textile printing. This ink set is used for printing information on a transfer medium by an inkjet printing apparatus.
[Patent Document 1] Japanese Unexamined Patent Publication No. 2013-231683
[Patent Document 2] Japanese Unexamined Patent Publication No. 2015-071385

The ink set usually contains an ink composition of three colors of yellow (Y), magenta (M), and cyan (C), or four colors obtained by adding black (BK) to these colors as basic colors.

These ink compositions contain a sublimation dye (disperse dye) as a color development component. Some of the sublimable dyes may be replaced by an alternative. The parameters for textile printing using the alternative are not necessarily consistent with the parameters for textile printing using the sublimable dye before replacement. For this reason, in a case where textile printing is performed under the same parameters, intended color development may not be obtained. In such a case, it may be necessary to adjust the parameters for textile printing.

Therefore, there is a need to more appropriately perform textile printing using the ink containing the sublimable dye.

### SUMMARY

According to an aspect of the present disclosure, there is provided a printing system including: a printing apparatus that performs printing of information on a medium by using an ink set including at least one other ink in addition to a magenta ink; a heat treatment apparatus that fixes the information printed on the medium by textile printing processing of the medium on which the information is printed; and a controller, in which the controller includes: a print data generation unit that generates print data from input data of information to be printed on the medium; a print control unit that prints the information on the medium by controlling ejection of the ink onto the medium based on the generated print data; and a textile printing parameter setting unit that sets, as a parameter of the textile printing processing, at least a heating temperature of the medium and a heating time of the medium, each of the inks included in the ink set contains a sublimable dye as a color development component, and the dye contained in the magenta ink is a disperse red 146, and the textile printing parameter setting unit is configured to: set a heating temperature in the textile printing processing to a first temperature higher than a heating temperature when the dye contained in the magenta ink is a disperse red 60; and set a heating time in the textile printing processing to a first time longer than a heating time when the dye contained in the magenta ink is a disperse red 60.

According to another aspect of the present disclosure, there is provided a method of dyeing a medium, the method including: a printing step of printing information on a medium by using an ink set including at least one other ink in addition to a magenta ink; and a heat treatment step of fixing the printed information onto the medium by textile printing processing of the medium on which the information is printed, in which each of the inks included in the ink set contains a sublimable dye as a color development component, and the dye contained in the magenta ink is a disperse red 146, a heating temperature in the textile printing processing is set to a first temperature higher than a heating temperature when the dye contained in the magenta ink is a disperse red 60, and a heating time in the textile printing processing is set to a first time longer than a heating time when the dye contained in the magenta ink is a disperse red 60.

According to still another aspect of the present disclosure, there is provided an ink set including at least one other ink in addition to a magenta ink, in which each of the inks included in the ink set contains a sublimable dye as a color development component, and the dye contained in the magenta ink is a disperse red 146.

### BRIEF DESCRIPTION OF THE DRAWINGS

FIG. 1 is a schematic configuration diagram of a printing system.

FIG. 2 is a flowchart illustrating processing performed by a controller.

### DETAILED DESCRIPTION OF EMBODIMENTS

Hereinafter, an embodiment of the present disclosure will be described.

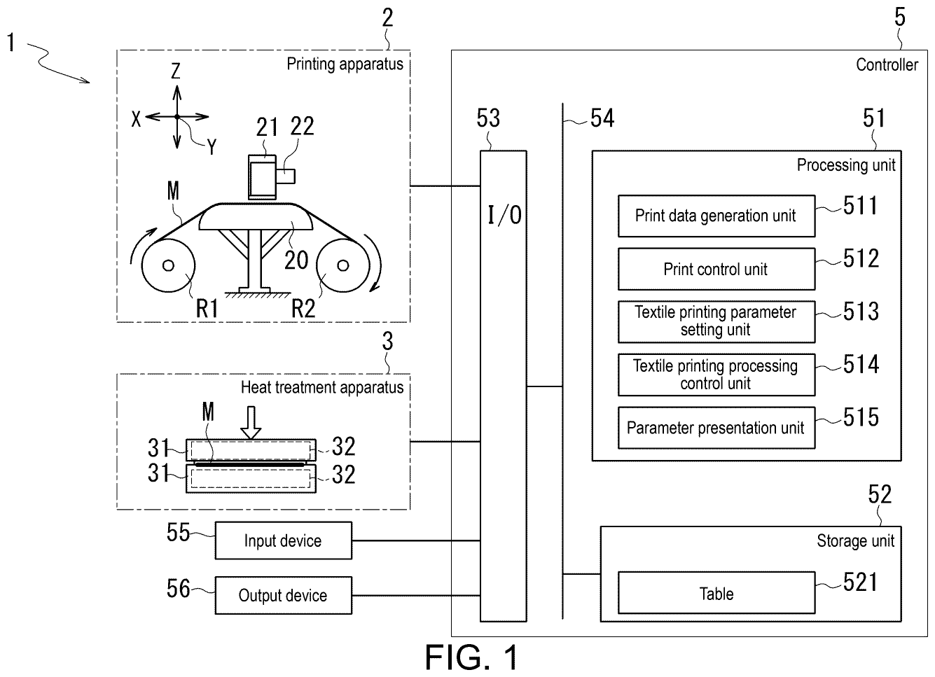

FIG. 1 is a schematic configuration diagram of a printing system.

As illustrated in FIG. 1, a printing system 1 includes a printing apparatus 2, a heat treatment apparatus 3, and a controller 5.

As an example, the printing apparatus 2 is an inkjet printer that prints information on a medium M by using an ink set of process colors.

As an example, the heat treatment apparatus 3 is a hot press machine. The heat treatment apparatus 3 performs textile printing processing on the medium M on which information is printed, and fixes the printed information on the medium M.

The controller 5 controls printing in the printing apparatus 2 and textile printing processing (heat treatment) in the heat treatment apparatus 3.

### [Medium M]

The medium M is a woven fabric (fabric, cloth) made of a polyester yarn which is a synthetic fiber.

The medium M may be a mixture of polyester as a main component and other synthetic fibers.

In the present embodiment, it is preferable to employ a medium M made of polyester having an opening temperature in a range of 150° C. to 180° C.

Here, in the polyester medium M dyed with a dye, the dye is held in gaps between molecular chains of the polyester constituting the medium M. The opening temperature means a temperature at which the molecular chains of the polyester constituting the medium M are loosened to such an extent that the dye can enter between the molecular chains of the polyester (gap is widened).

The medium M may be a plain weave or a twill weave of polyester yarns.

Examples of polyester fabrics (medium) include tropical (100% polyester), pongee (100% polyester), smooth (100% polyester), honeycomb (100% polyester), and Lycra (registered trademark) (15% polyurethane and 85% polyester).

Here, tropical and pongee are fabrics used for advertising and promotional tools such as roller blinds, pennants, and banners.

The “information” to be printed on the medium M does not mean only the “text” or the “pattern” of the printed design, but also includes characters, symbols, patterns, and the like.

For printing of information, an ink containing a sublimable dye as a color development component (dye-based ink) is used.

The printing apparatus 2 used for printing information includes an ink set of process colors.

The process colors are yellow (Y), magenta (M), cyan (C), and black (BK), which are basic colors used in full-color printing.

In the present embodiment, the ink set of the printing apparatus 2 may be an ink set including at least one ink of a yellow (Y) ink, a cyan (C) ink, and a black (BK) ink in addition to a magenta (M) ink. Note that the ink set may further include a green ink, a purple ink, and an orange ink which are complementary colors to the basic color inks.

The printing apparatus 2 includes a head (an inkjet head, not illustrated) corresponding to each color of the ink set. The head for each color is mounted on a carriage 21 that moves in a Y direction. The carriage 21 is supported by a Y bar 22 disposed above a platen 20 so as to be movable in the Y direction.

The medium Mis disposed over an upper surface of the platen 20. A region of the medium M disposed over the platen 20 is a region between a feed roller R1 and a winding roller R2. The medium Mis movable in an X direction by a drive mechanism (not illustrated).

The information is printed on the medium M fed from the feed roller R1 in a region of the platen 20 by using the ink ejected from the inkjet head. The medium M on which printing of the information is completed is finally wound around the winding roller R2. The medium M wound around the winding roller R2 is cut to a predetermined length before being supplied to the heat treatment apparatus 3.

In the printing apparatus 2, printing is performed while the carriage 21 and the medium M are relatively displaced in the Y direction and the X direction by a drive mechanism (not illustrated).

The medium M on which the information is printed is supplied to the heat treatment apparatus 3 in a state of being cut to a predetermined length.

The heat treatment apparatus 3 includes a pair of heating plates 31 and 31. A heater 32 is provided inside the heating plate 31.

The heat treatment apparatus 3 fixes the printed information onto the medium M by applying pressure to the medium M for a predetermined time in a state where the medium M is held by the pair of heating plates 31 and 31. The color development and the quality of the information printed on the medium M change depending on a heating temperature, a heating time, and a pressure at this time.

The controller 5 includes a processing unit 51, a storage unit 52, and an input/output port (I/O) 53. The processing unit 51, the storage unit 52, and the input/output port 53 are connected to each other via a bus 54.

The printing apparatus 2, the heat treatment apparatus 3, an input device 55, and an output device 56 are connected to the input/output port 53 of the controller 5.

In the present embodiment, a case where the printing apparatus 2 and the heat treatment apparatus 3 are connected to the controller 5 in a one-to-one relationship is illustrated. On the other hand, the printing apparatus 2 and the heat treatment apparatus 3 may be connected to the controller 5 via a network such that information can be exchanged, regardless of whether the connection is wired or wireless.

The input device 55 is an interface for inputting an instruction to the controller 5. Examples of the input device 55 include a keyboard, a mouse, a touch panel, and a terminal carried by an operator.

The output device 56 is an interface for outputting information such as characters, images, and sounds. Examples of the output device 56 include a monitor, a speaker, and a terminal carried by an operator.

The processing unit 51 is a processor such as a CPU or a GPU, and executes processing defined by a program based on the program stored in the storage unit 52.

The storage unit 52 is a recording medium capable of holding and rewriting information, such as an HDD, an SSD, and a memory.

The storage unit 52 stores a program of each piece of processing performed by the processing unit 51, and the like. Furthermore, information generated during the processing is stored in the storage unit 52.

Note that the function as the storage unit 52 may be provided to an external server (not illustrated) connected to the controller 5 via a network (not illustrated).

The storage unit 52 stores, in addition to various programs, a table 521 in which parameters of textile printing processing in the heat treatment apparatus 3 are summarized.

Here, examples of the parameters of textile printing processing include at least a heating temperature T of the medium M and a heating time t of the medium M in the heat treatment apparatus 3.

In a case of using a direct type textile printing method, the textile printing processing preferably includes, as parameters, a heating temperature T, a heating time t, an amount of heated air, and the like. In a case of using a transfer type textile printing method, the textile printing processing preferably includes, as parameters, a heating temperature T, a heating time t, and the like.

Here, the inventors of the present application have confirmed that, in a case where the dye contained in the magenta ink included in the ink set is changed from the disperse red 60 to the disperse red 146, a difference occurred in color development and quality of the printed information even when the parameters of the textile printing processing are the same.

Then, the inventors variously studied the parameters of the textile printing processing in a case where the dye is changed from the disperse red 60 to the disperse red 146, and found the parameters of the textile printing processing that can obtain almost the same color development and quality as when the dye contained in the magenta ink is the disperse red 60.

Specifically, the inventors found the parameters of the textile printing processing (the heating temperature T and the heating time t) that can obtain almost the same color development and quality as when the dye contained in the magenta ink is the disperse red 60.

The table 521 stores textile printing processing parameters corresponding to the ink set mounted on the printing apparatus 2.

As an example, (a) different textile printing processing parameters are determined according to a proportion of the magenta ink to the total usage amount of the ink used for printing the information. (b) Different textile printing processing parameters are determined according to a proportion of an area of a region where the magenta ink is used to the total area of a region where the information is printed.

The inventors of the present application found that, through experiments and simulations, (a) a degree of influence of the change in the dye is correlated with the proportion of the magenta ink to the total usage amount of the ink used for printing the information, and (b) a degree of influence of the change in the dye is correlated with the area of the region where the magenta ink is used to the total area of the region where the information is printed.

In the table 521, the textile printing processing parameters are registered based on a tendency obtained through these experiments and simulations.

Further, in the table 521, color development data is stored in association with the textile printing processing parameters. The color development data is data (for example, image data) that allows a user to visually recognize a color development state on the medium M after the textile printing processing is performed. In the table 521, one piece of color development data is registered in association with each of the textile printing processing parameters that are registered.

Here, in the printing apparatus 2, a plurality of ink sets are prepared which contain different inks in addition to the magenta ink containing the disperse red 146. Thus, in the table 521, a relationship between the proportion of the magenta ink and the textile printing processing parameter is prepared for each of a plurality of ink sets.

Therefore, by referring to the table 521 based on a type of the ink set to be used, (a) the proportion of the magenta ink to the total usage amount of the ink used for printing the information, (b) the proportion of the area of the region where the magenta ink is used to the total area of the region where the information is printed, and the like, the most preferable textile printing processing parameter at the timing can be extracted.

The processing unit 51 includes, as functional blocks for controlling printing in the printing apparatus 2 and textile printing processing in the heat treatment apparatus 3, a print data generation unit 511, a print control unit 512, a textile printing parameter setting unit 513, a textile printing processing control unit 514, and a parameter presentation unit 515.

The print data generation unit 511 generates print data converted into a printable format by processing the input image data (input data, digital data).

The print data generation unit 511 reads a program (raster image processor (RIP) software) stored in the storage unit 52, and executes data conversion processing of converting a vector image or text data into a raster format, and color adjustment processing of performing color correction or color separation.

The print control unit 512 performs printing by the printing apparatus 2 based on the print data.

The print control unit 512 controls a relative displacement of the carriage 21 and the medium M in an X-Y direction by driving the drive mechanism (not illustrated) of the printing apparatus 2. At this time, the print control unit 512 prints information on the medium M by controlling ejection of ink droplets onto the medium M based on the print data.

The parameter presentation unit 515 presents a plurality of candidates for the textile printing processing parameter before setting the textile printing parameter.

As an example, the parameter presentation unit 515 calculates the total usage amount obtained by adding the usage amount of each ink included in the ink set based on the print data generated by the print data generation unit 511. Then, the textile printing parameter setting unit 513 calculates a proportion of the magenta ink to the calculated total usage amount.

The textile printing parameter setting unit 513 acquires a plurality of (at least two) textile printing processing parameters by referring to the table 521 based on the type of the ink set to be used in the printing apparatus 2 and the calculated proportion of the magenta ink.

Then, the parameter presentation unit 515 displays the plurality of acquired textile printing processing parameters on the display device 56 (for example, a monitor). At this time, color development data indicating a color development state when textile printing processing is performed under the textile printing processing parameter is displayed in parallel in association with the textile printing processing parameter.

Thereby, the display device 56 presents at least two textile printing processing parameters and the image data that allows the user to visually recognize the color development state when textile printing processing is performed under each of the textile printing processing parameters side by side.

Thereby, the user selects one textile printing processing parameter from the plurality of presented textile printing processing parameters.

Note that the textile printing processing parameter may be acquired by using, instead of (a) the proportion of the magenta ink to the total usage amount of the ink used for printing the information, (b) the proportion of the area of the region where the magenta ink is used to the total area of the region where the information is printed.

In a case where one textile printing processing parameter is designated from among the plurality of presented candidates for the heat treatment parameters, the textile printing parameter setting unit 513 sets the designated textile printing processing parameter as a textile printing processing parameter to be performed by the heat treatment apparatus 3.

Note that the textile printing parameter setting unit 513 may directly acquire the textile printing processing parameter by referring to the table 521 using the type of the ink set, (a) the proportion of the magenta ink to the total usage amount of the ink used for printing the information, and (b) the proportion of the area of the region where the magenta ink is used to the total area of the region where the information is printed, and set the acquired textile printing processing parameter as the textile printing processing parameter to be performed by the heat treatment apparatus 3.

The textile printing processing control unit 514 controls textile printing processing (heat treatment) in the heat treatment apparatus 3 based on the set textile printing processing parameter.

The textile printing processing control unit 514 performs textile printing processing on the medium M by driving the drive mechanism (not illustrated) and the heater 32 of the heat treatment apparatus 3 and controlling a pressure, a temperature, and a time when the medium M is held by the hot press machine.

[Magenta Ink]

In the ink in which the disperse red 60 is adopted as a color development component, an ink in which the disperse red 60 is simply replaced by the disperse red 146 without changing other components (solvent components, additives, and the like) except the color development component is used as the magenta ink for evaluation.

In the present embodiment, the disperse red 146 represented by the following expression (1) is used as a color development component.

Note that, instead of the methoxy group (—OCH₃), an ethoxy group (—OCH₂—CH₃) or an n-propoxy group (—OCH₂—CH₂—CH₃) may be used.

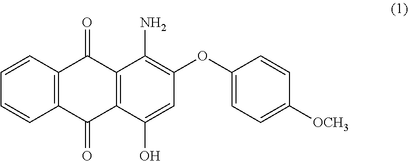 [SMILES: COc1ccc(Oc2cc(O)c3c(c2N)C(=O)c2ccccc2C3=O)cc1]

In the textile printing processing, the dye penetrates between the molecular chains of the polyester included in the medium M and dyes the medium M. For this reason, in a case where the substituent becomes large, there is a possibility of hindering the dye from penetrating between molecular chains. Therefore, preferably, the change of the substituent of the methoxy group portion is limited to an ethoxy group.

[Ink Set of Printing Apparatus 2]

In the ink set for the process colors which are set in the printing apparatus 2, only the magenta (M) ink was replaced by a magenta ink for evaluation.

[Medium for Evaluation]

As the medium M for evaluation, tropical (100% polyester), pongee (100% polyester), smooth (100% polyester), honeycomb (100% polyester), and Lycra (registered trademark) (15% polyurethane to 85% polyester) were adopted.

Note that a test piece of 25 cm×25 cm was prepared from the medium M on which the information is printed, the textile printing processing is performed on the test piece, and evaluation items including the color development, the presence or absence of yellowing of the medium, and the presence or absence of dimensional change of the medium were set.

[Evaluation of Parameter of Textile Printing Processing]

For the medium M on which information is printed using the process inks including the magenta ink in which the disperse red 146 is adopted as the color development component, evaluation of the parameter of the textile printing processing was performed by changing the heating temperature and the heating time among the parameters of the textile printing processing.

Here, in the textile printing processing, the heating temperature T was set to 180° C., 190° C., 200° C., 210° C., and 220° C., and the heating time t was set to 30 seconds, 60 seconds, 90 seconds, 120 seconds, and 150 seconds.

Further, in a case of the process ink including a magenta ink in which the disperse red 60 is used as the color development component, the standard parameters of the textile printing processing are a heating temperature Ts of 180° C. to 210° C. and a heating time ts of 30 seconds to 60 seconds.

In the evaluation of the obtained medium M after the textile printing processing, (a) the presence or absence of yellowing or shrinkage of the medium M (fabric), (b) the color development of the ink (printed information), and (c) the quality of the printed information (presence or absence of ink smearing) were used as evaluation parameters.

(a) For the “yellowing” in the evaluation items, a difference in color tone of the medium between before and after textile printing processing was visually confirmed.

(a) For the “shrinkage” in the evaluation items, the dimensional change of the medium between before and after the textile printing processing was measured.

As an example, in the case of “yellowing” in the evaluation items, a degree of yellowing was evaluated in five grades of 1 point to 5 points. In the case of “shrinkage” in the evaluation items, the dimensional change of the medium in the longitudinal direction and the lateral direction was actually measured, and the change rate to the original dimension was evaluated in five grades of 1 point to 5 points. As an example, in a case where the change rate was lower than 2%, 4 points or 5 points were set according to the change rate. In a case where the change rate was equal to or higher than 2%, 1 point to 3 points were set according to the change rate.

In the following table, “◯: no yellowing and no shrinkage, A: slight yellowing and slight shrinkage” was determined from the evaluation values of “yellowing” and “shrinkage”.

(b) The color development in the evaluation items was evaluated by a color difference ΔE (average value of ink duties of 10% to 100%) between a printed matter (printed matter for comparison) using an ink containing the disperse red 60 as a color development component and a printed matter (printed matter for evaluation) using an ink containing the disperse red 146 as a color development component.

In the following table, “◯: ΔE<3, Δ:3≤ΔE<5”.

(c) For the print quality in the evaluation items, the print quality on the medium after the textile printing processing was visually confirmed.

In the following table, “◯: no problem, Δ: slightly poor”.

(d) The comprehensive evaluation of the evaluation items was performed by scoring each of the evaluation items (a) to (c) and calculating an average value of the scores of the evaluation items.

In the following table, 5.0 points to 4.1 points are set as “⊚”, 4.0 points to 3.1 points are set as “◯”, and 3.0 points to 2.1 points are set as “Δ”.

### <Tropical>

### (a) Yellowing/Shrinkage

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ◯ |
| | 210 | ◯ | ◯ | ◯ | ◯ |
| | 220 | ◯ | ◯ | ◯ | Δ |

### (b) Color Development

Heating time (sec)

| | | 30 | 60 | 90 | 120 |
|---|---|---|---|---|---|
| Heating | 180 | | | | |
| temperature | 190 | | | | Δ |
| (° C.) | 200 | | | ◯ | ◯ |
| | 210 | | ◯ | ◯ | ◯ |
| | 220 | Δ | ◯ | Δ | Δ |

### (c) Quality

Heating time (sec)

| | | | |
|---|---|---|---|
| 30 | 60 | 90 | 120 |

| | | | | |
|---|---|---|---|---|
| Heating | 180 | | | |
| temperature | 190 | | | |
| (° C.) | 200 | | | Δ |
| | 210 | | ◯ | ◯ |
| | 220 | Δ | ◯ | ◯ |

### (d) Overall Evaluation

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ⊚ | ⊚ |
| | 210 | Δ | ◯ | ⊚ | ⊚ |
| | 220 | ◯ | ⊚ | ⊚ | ◯ |

In a case of tropical, good results were obtained at 200° C. to 210° C. and 90 seconds to 120 seconds, and 220° C. and 60 seconds to 90 seconds.

In a case of tropical, it was confirmed that, by setting the heating temperature to a temperature which is higher by at least 20° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, the quality becomes substantially equivalent to the quality in a case of the ink containing the disperse red 60 as the color development component.

### <Pongee>

### (a) Yellowing/Shrinkage

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ◯ |
| | 210 | ◯ | ◯ | ◯ | ◯ |
| | 220 | ◯ | ◯ | ◯ | Δ |

### (b) Color Development

Heating time (sec)

| | | 30 | 60 | 90 | 120 |
|---|---|---|---|---|---|
| Heating | 180 | | | | |
| temperature | 190 | | | | Δ |
| (° C.) | 200 | | Δ | ◯ | ◯ |
| | 210 | | ◯ | ◯ | ◯ |
| | 220 | ◯ | ◯ | ◯ | Δ |

### (c) Quality

Heating time (sec)

| | | 30 | 60 | 90 | 120 |
|---|---|---|---|---|---|
| Heating | 180 | | | | |
| temperature | 190 | | | | |
| (° C.) | 200 | | | | Δ |
| | 210 | | | ◯ | ◯ |
| | 220 | | Δ | ◯ | ◯ |

### (d) Overall Evaluation

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ⊚ |
| | 210 | ◯ | ◯ | ⊚ | ⊚ |
| | 220 | ◯ | ⊚ | ⊚ | ⊚ |

In a case of pongee, good results were obtained at 200° C. and 120 seconds, 210° C. and 90 seconds to 120 seconds, and 220° C. and 60 seconds to 120 seconds.

In a case of pongee, it was confirmed that, by setting the heating temperature to a temperature which is higher by at least 20° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, the quality becomes substantially equivalent to the quality in a case of the ink containing the disperse red 60 as the color development component.

### <Smooth>

### (a) Yellowing/Shrinkage

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ◯ |
| | 210 | ◯ | ◯ | ◯ | ◯ |
| | 220 | ◯ | ◯ | Δ | Δ |

### (b) Color Development

Heating time (sec)

| | | 30 | 60 | 90 | 120 |
|---|---|---|---|---|---|
| Heating | 180 | | | | |
| temperature | 190 | | | | |
| (° C.) | 200 | | | | ◯ |
| | 210 | | | ◯ | ◯ |
| | 220 | | ◯ | ◯ | ◯ |

### (c) Quality

Heating time (sec)

| | | 30 | 60 | 90 | 120 |
|---|---|---|---|---|---|
| Heating | 180 | | | | |
| temperature | 190 | | | | |
| (° C.) | 200 | | | | Δ |
| | 210 | | | Δ | ◯ |
| | 220 | | Δ | ◯ | ◯ |

### (d) Overall Evaluation

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ⊚ |
| | 210 | Δ | ◯ | ⊚ | ⊚ |
| | 220 | ◯ | ⊚ | ⊚ | ⊚ |

In a case of smooth, good results were obtained at 200° C. and 120 seconds, 210° C. and 90 seconds to 120 seconds, and 220° C. and 60 seconds to 120 seconds.

In a case of smooth, it was confirmed that, by setting the heating temperature to a temperature which is higher by at least 20° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, the quality was good, but the quality was inferior to the quality in a case of the ink containing the disperse red 60 as the color development component.

In a case of focusing on color development, it was confirmed that, by setting the heating temperature to a temperature which is higher by at least 30° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, a good quality was obtained.

### <Honeycomb>

### (a) Yellowing/Shrinkage

Heating time (sec)

| | | 30 | 60 | 90 | 120 |
|---|---|---|---|---|---|
| Heating | 180 | | | ◯ | ◯ |
| temperature | 190 | | | ◯ | ◯ |
| (° C.) | 200 | | ◯ | ◯ | ◯ |
| | 210 | ◯ | ◯ | ◯ | ◯ |
| | 220 | ◯ | ◯ | ◯ | Δ |

### (b) Color Development

Heating time (sec)

| | | 30 | 60 | 90 | 120 |
|---|---|---|---|---|---|
| Heating | 180 | | | | |
| temperature | 190 | | | | |
| (° C.) | 200 | | | | ◯ |
| | 210 | | | Δ | ◯ |
| | 220 | | ◯ | ◯ | ◯ |

### (c) Quality

Heating time (sec)

| | | 30 | 60 | 90 | 120 |
|---|---|---|---|---|---|
| Heating | 180 | | | | |
| temperature | 190 | | | | |
| (° C.) | 200 | | | | Δ |
| | 210 | | | | Δ |
| | 220 | | | ◯ | ◯ |

### (d) Overall Evaluation

Heating time (sec)

| | | 30 | 60 | 90 | 120 |
|---|---|---|---|---|---|
| Heating | 180 | | | Δ | Δ |
| temperature | 190 | | | Δ | ◯ |
| (° C.) | 200 | | Δ | ◯ | ⊚ |
| | 210 | Δ | ◯ | ◯ | ⊚ |
| | 220 | Δ | ◯ | ⊚ | ⊚ |

In a case of honeycomb, good results were obtained at 200° C. and 120 seconds, 210° C. and 120 seconds, 220° C. and 90 seconds to 120 seconds.

In a case of honeycomb, it was confirmed that, by setting the heating temperature to a temperature which is higher by at least 20° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, the quality was good, but the quality was inferior to the quality in a case of the ink containing the disperse red 60 as the color development component.

### <Lycra>

### (a) Yellowing/Shrinkage

Heating time (sec)

| | | 30 | 60 | 90 | 120 |
|---|---|---|---|---|---|
| Heating | 180 | | | X | X |
| temperature | 190 | | | Δ | Δ |
| (° C.) | 200 | | Δ | Δ | Δ |
| | 210 | Δ | Δ | Δ | Δ |
| | 220 | Δ | Δ | X | X |

### (b) Color Development

Heating time (sec)

| | | 30 | 60 | 90 | 120 |
|---|---|---|---|---|---|
| Heating | 180 | | | | |
| temperature | 190 | | | | Δ |
| (° C.) | 200 | | | Δ | Δ |
| | 210 | | Δ | Δ | |
| | 220 | Δ | | | |

### (c) Quality

Heating time (sec)

| | | 30 | 60 | 90 | 120 |
|---|---|---|---|---|---|
| Heating | 180 | | | | |
| temperature | 190 | | | | |
| (° C.) | 200 | | | ◯ | ◯ |
| | 210 | | ◯ | ◯ | ◯ |
| | 220 | | | | |

### (d) Overall Evaluation

Heating time (sec)

| | | 30 | 60 | 90 | 120 |
|---|---|---|---|---|---|
| Heating | 180 | | | Δ | Δ |
| temperature | 190 | | | Δ | Δ |
| (° C.) | 200 | | Δ | ◯ | ◯ |
| | 210 | Δ | ◯ | ◯ | ◯ |
| | 220 | ◯ | Δ | | |

In a case of Lycra (registered trademark), it was confirmed that yellowing and stretching were large when the parameters were adjusted for color development and quality.

In a case of Lycra (registered trademark), it was confirmed that, by setting the heating temperature to a temperature which is higher by at least 20° C. and setting the heating time to a treatment time which is longer by 60 seconds at the maximum than the parameters (heating temperature: 180° C., heating time: 60 seconds) of the textile printing processing in a case of the ink containing the disperse red 60 as the color development component, the quality was good, but the quality was inferior to the quality in a case of the ink containing the disperse red 60 as the color development component.

From the above evaluation results, it was confirmed that, in the case of tropical, pongee, and smooth, good results were obtained by setting the parameters of the textile printing processing to a temperature which is higher by 10° C. to 60° C., preferably, a temperature which is higher by 20° C. to 40° C., and a time which is longer by 100 seconds at the maximum, preferably, a time which is longer by 60 seconds, than the textile printing parameters (180° C., 60 seconds) in the case of the printed matter using the ink containing the disperse red 60 as the color development component.

Hereinafter, processing performed by the controller 5 will be described by taking, as an example, a case where an image is printed by using, as the medium M, tropical.

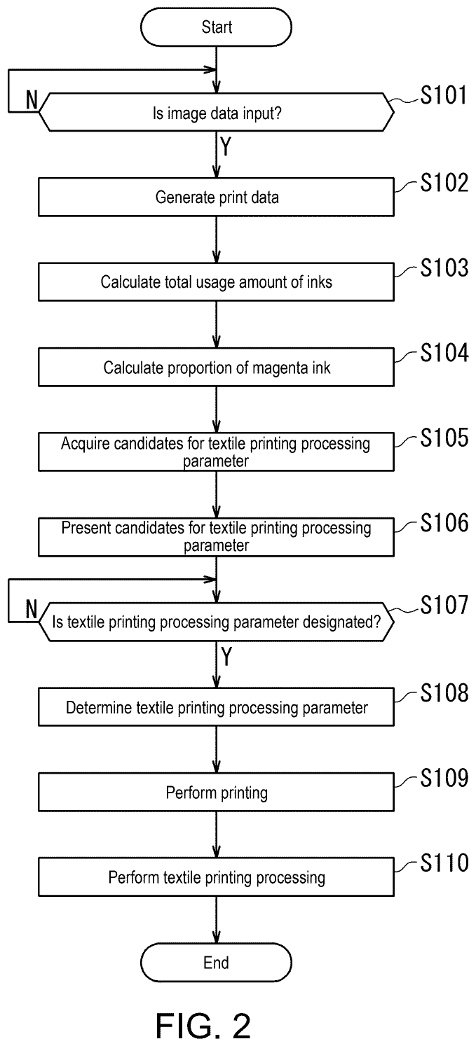

FIG. 2 is a flowchart illustrating processing performed by the controller 5.

In the controller 5, in a case where image data (input data) of information to be printed on the medium M is input (Yes in step S101), the print data generation unit 511 generates print data from the input image data (step S102).

In a case where the print data is generated, the textile printing parameter setting unit 513 calculates a total usage amount obtained by adding the usage amounts of the inks included in the ink set based on the generated print data (step S103).

Subsequently, the textile printing parameter setting unit 513 calculates a proportion of the magenta ink to the calculated total usage amount (step S104).

Further, the textile printing parameter setting unit 513 acquires at least two candidates for the condition of the textile printing processing (textile printing processing parameter) determined according to the calculated proportion by referring to the table 521 based on the calculated proportion (step S105).

The parameter presentation unit 515 displays the acquired candidates for the parameter of the textile printing processing on the output device 56 (for example, a monitor) (step S106). At this time, the parameter presentation unit 515 displays the acquired candidates for the parameter of the textile printing processing and image data that allows the user to visually recognize a color development state when textile printing processing is performed under each parameter of the textile printing processing side by side.

Thereby, the user can confirm the influence of the difference in the parameter of the textile printing processing on the color development and quality, and then determine the parameter of the textile printing processing. Then, the user operates the input device 55 to designate the textile printing processing parameter selected by the user.

In a case where an instruction to designate the textile printing processing selected by the user is input (Yes in step S107), the textile printing parameter setting unit 513 determines the instructed parameter of the textile printing processing as the parameter of the textile printing processing to be performed by the heat treatment apparatus 3 (step S108).

In a case where the parameter of the textile printing processing is determined (step S108), the print control unit 512 outputs the print data generated in step S102 to the printing apparatus 2. Thereby, the information is printed on the medium M (step S109).

Then, heat treatment of the medium M on which the information is printed is performed under the textile printing processing parameters (heat treatment parameters) determined in step S108 (step S110).

As described above, in the table 521, the textile printing processing parameters (the first temperature T1 and the first time t1) optimized through experiments and simulations, and the proportion of the magenta ink containing the disperse red 146 are prepared for each of the plurality of ink sets.

Thereby, by performing the textile printing processing in the heat treatment apparatus 3 based on the acquired parameters of the textile printing processing by referring to the table 521, even in a case where the dye of the magenta ink is changed from a disperse red 60 to a disperse red 146, it is possible to prevent a difference in color development and quality between before and after changing the dye.

### Modification Example

In the embodiment described above, the description has been given by taking, as an example, a case where the textile printing processing parameters (the first temperature T1 and the first time t1) optimized through experiments and simulations are defined in the table 521.

The amounts of correction of the textile printing processing parameters (first temperature T1 and first time t1) may be registered in association with (a) the proportion of the magenta ink to the total usage amount of the inks used for printing the information, and (b) the proportion of the area of the region where the magenta ink is used to the total area of the region where the information is printed.

In this case, by using the correction amount acquired with reference to the table 521, the parameters (heating temperature and heating time) of the textile printing processing can be corrected, and then the corrected parameters can be presented to the user. Even in the configuration, it is possible to appropriately perform textile printing even in a case where the dye is changed from a disperse red 60 to a disperse red 146 without causing a large difference in print quality such as color development.

In the embodiment described above, the case where the heat treatment apparatus 3 is a hot press machine has been exemplified. Instead of the hot press machine, a drying furnace through which the medium M on which information is printed continuously passes may be employed.

In this case, the medium passes through the drying furnace maintained at the heat treatment temperature, and thus, the textile printing processing is performed. In the hot press machine, the textile printing processing is performed in a so-called batch manner, but in the case of using a drying furnace, the textile printing processing is performed in a continuous manner. Therefore, improvement in production efficiency of printed matter after the textile printing processing can be expected.

In the embodiment described above, the description has been given by taking, as an example, a case where, from the print data generated from the input data, (a) the proportion of the magenta ink to the total usage amount of the inks used for printing the information and (b) the proportion of the area of the region where the magenta ink is used to the total area of the region where the information is printed are calculated.

It is also possible to perform learning of calculation data for the proportions of (a) and (b) from the print data, and then calculate the proportions of (a) and (b) from the print data by using the learning data.

As described above, the printing system 1 according to the present embodiment has the following configuration.

(1) A printing system 1 includes: a printing apparatus 2 that performs printing of information on a medium M based on print data by using an ink set including at least one other ink in addition to a magenta ink; a heat treatment apparatus 3 that fixes the information printed on the medium M by textile printing processing of the medium M on which the information is printed; and a controller 5.

The controller 5 includes: a print data generation unit 511 that generates print data from input data of information to be printed on the medium M; a print control unit 512 that prints the information on the medium M by controlling ejection of the ink onto the medium M based on the generated print data; and a textile printing parameter setting unit 513 that sets at least a heating temperature T of the medium M and a heating time t of the medium M in textile printing processing.

Each of the inks included in the ink set contains a sublimable dye as a color development component, and the dye contained in the magenta ink is a disperse red 146.

The textile printing parameter setting unit 513 sets a heating temperature T in the textile printing processing to a first temperature T1 higher than a heating temperature Ts when the dye contained in the magenta ink is a disperse red 60.

The textile printing parameter setting unit 513 sets a heating time t in the textile printing processing to a first time t1 longer than a heating time ts when the dye contained in the magenta ink is a disperse red 60.

With the configuration, it is possible to provide a printing system that can appropriately perform textile printing even in a case where the dye is changed from a disperse red 60 to a disperse red 146 without causing a large difference in print quality such as color development.

(2) In (1), the first temperature T1 is a temperature that is higher by 10° C. to 40° C. than a heating temperature Ts when the dye contained in the magenta ink is a disperse red 60, and the first time t1 is a time that is longer by 100 seconds at the maximum than a heating time ts when the dye contained in the magenta ink is a disperse red 60.

With the configuration, it is possible to provide a printing system that can appropriately perform textile printing even in a case where the dye is changed from a disperse red 60 to a disperse red 146 without causing a large difference in print quality such as color development.

Here, the disperse red 60, which has been widely used as a magenta coloring material of an ink (disperse dye ink) containing a sublimable dye, may be prohibited, and it is necessary to select an alternative coloring material.

The sublimable dye (coloring material) contained in the ink develops the color through heat treatment (textile printing processing) after printing. Meanwhile, the fabric that can use the sublimable ink is a polyester (or nylon) or polyester blend. For this reason, depending on the temperature and the treatment time in the heat treatment, deterioration of texture or deformation of the fabric may occur.

In the heat treatment (textile printing processing), general color development parameters are a heating temperature of 180° C. to 210° C. and a heating time of 30 seconds to 60 seconds. If the heating temperature is too high, depending on the type of the coloring material, a phenomenon of color loss (bleed-through) may proceed to the back side of the fabric, leading to deterioration of the color developability of the surface of the fabric.

In a case where the dye is changed from the disperse red 60 to the disperse red 146, it is possible to obtain desired color development while preventing deterioration of texture and deformation of the fabric by setting the parameters of the textile printing processing.

(I) In (1) or (2), the ink set includes at least one other ink among a yellow ink, a cyan ink, and a black ink, in addition to the magenta ink.

With the configuration, in the process inks used in the printing apparatus 2, even in a case where the dye of the magenta ink is changed from the disperse red 60 to the disperse red 146, it is possible to perform textile printing with substantially the same color development and quality as before changing the dye.

(3) In any one of (1), (2), and (I), the textile printing parameter setting unit 513 calculates a total usage amount obtained by adding usage amounts of each of the inks included in the ink set based on the generated print data, calculates a proportion of the magenta ink to the calculated total usage amount, and sets a parameter of the textile printing processing (a heat treatment parameter) based on the calculated proportion.

A degree of influence of the change in the dye is correlated with the proportion of the magenta ink to the total usage amount of the inks used for printing the information.

By changing the parameter of the textile printing processing according to the proportion of the magenta ink to the total usage amount of the inks, it is possible to set the parameter of the textile printing processing in consideration of the influence of the change in the dye on the color development and quality. Thereby, it is possible to prevent a difference in color development and quality between before and after changing the dye.

The proportion of the magenta ink to the total usage amount of the inks used for printing the information can be calculated from the print data. Thereby, it is possible to set the parameter for the textile printing processing while reducing a processing burden required for setting the parameter of the textile printing processing.

(4) In any one of (1) to (3) and (I), the textile printing parameter setting unit 513 calculates an area of a region where the magenta ink is used based on the generated print data, calculates a proportion of the area of the region where the magenta ink is used to a total printing area defined by the print data, and sets the heat treatment parameter based on the calculated proportion.

A degree of influence of the change in the dye is correlated with the area of the region where the magenta ink is used to the total area of the region where the information is printed.

By changing the parameter of the textile printing processing according to the proportion of the area of the region where the magenta ink is used to the total area of the region where the information is printed, it is possible to set the parameter of the textile printing processing in consideration of the influence of the change in the dye on the color development and quality. Thereby, it is possible to prevent a difference in color development and quality between before and after changing the dye.

Further, the proportion of the area of the region where the magenta ink is used to the total area of the region where the information is printed can be calculated from the print data. Thereby, it is possible to set the parameter for the textile printing processing while reducing a processing burden required for setting the parameter of the textile printing processing.

(5) In any one of (1) to (4) and (I), the controller 5 includes a table 521 that stores the proportion of the magenta ink, and the first temperature T1 (heating temperature) and the first time t1 (heating time) in association with each other.

The textile printing parameter setting unit 513 sets the first temperature T1 and the first time t1 by referring to the table 521 based on the calculated proportion.

The first temperature T1 and the first time t1 can be defined in the table 521 based on past experiment results, simulations, and the like, for the proportion of the magenta ink to the total usage amount of the inks used for printing the information.

With the configuration, the textile printing parameter setting unit 513 can determine appropriate values of the first temperature T1 and the first time t1 by referring to the table 521 based on the calculated proportion.

Thereby, even in a case where the dye of the magenta ink is changed from a disperse red 60 to a disperse red 146, it is possible to prevent a difference in color development and quality between before and after changing the dye.

(6) In any one of (1) to (5) and (I), in the printing apparatus 2, a plurality of ink sets are prepared which contain different inks in addition to the magenta ink.

In the table 521, a relationship between the proportion of the magenta ink, the first temperature T1, and the first time t1 is prepared for each of a plurality of ink sets.

With the configuration, the proportion of the magenta ink, the first temperature T1, and the first time t1 are defined for each of the plurality of ink sets in which a combination of the contained inks is different. Thus, even in a case where the ink set to be used in the printing apparatus 2 is changed, it is possible to prevent a difference in color development and quality between before and after changing the dye.

Thereby, even in a case where the ink set includes an ink containing other dyes, such as a purple color dye and an orange color dye, in addition to the magenta ink, it is possible to prevent a difference in the color development and quality between before and after changing the dye.

(7) The controller 5 includes a parameter presentation unit 515 that presents at least two candidates for the parameter of the textile printing processing.

The table 521 stores color development data in which a color development state of the medium M after the textile printing processing is recorded for each parameter of the textile printing processing.

The parameter presentation unit 515 presents, in a case of presenting the candidates for the parameter of the textile printing processing, the color development data when the textile printing processing is performed under the presented parameter of the textile printing processing together with the candidates.

With the configuration, the user can confirm the influence of the difference in the parameter of the textile printing processing on the color development and quality, and then set the parameter of the textile printing processing. Thereby, it is possible to reduce a possibility that the color development and the quality after the textile printing processing greatly deviate from the color development and the quality desired by the user.

Further, in a case where the color development and the quality after textile printing greatly deviate from the color development and the quality desired by the user, printing is performed again. By setting the parameter of the textile printing processing after the user confirms the influence, it is possible to reduce a possibility that printing is performed again. In a case where printing is performed again, the total working time increases, and the yield in the production of the medium on which the information is printed decreases. With the configuration, it is possible to suitably prevent an occurrence of such a situation.

The present disclosure can also be specified as a method of dyeing a medium on which information is printed using an ink set including at least one other ink in addition to the magenta ink.

(8) There is provided a method of dyeing a medium, the method including: a printing step of printing information on a medium by using an ink set including at least one other ink in addition to a magenta ink; and a heat treatment step of fixing the printed information onto the medium by textile printing processing of the medium on which the information is printed.

Each of the inks included in the ink set contains a sublimable dye as a color development component.

The dye contained in the magenta ink is a disperse red 146.

A heating temperature T in the textile printing processing is set to a first temperature T1 higher than a heating temperature Ts when the dye contained in the magenta ink is a disperse red 60.

A heating time t in the textile printing processing is set to a first time t1 longer than a heating time ts when the dye contained in the magenta ink is a disperse red 60.

With the configuration, even in a case where the dye of the magenta ink is changed from a disperse red 60 to a disperse red 146, it is possible to prevent a difference in color development and quality between before and after changing the dye.

(9) In (8), the first temperature T1 is a temperature that is higher by 10° C. to 40° C. than a heating temperature Ts when the dye contained in the magenta ink is a disperse red 60, and the first time t1 is a time that is longer by 100 seconds at the maximum than a heating time ts when the dye contained in the magenta ink is a disperse red 60.

With the configuration, even in a case where the dye of the magenta ink is changed from a disperse red 60 to a disperse red 146, it is possible to prevent a difference in color development and quality between before and after changing the dye.

The present disclosure can also be specified as an ink set.

(10) There is provided an ink set including at least one other ink in addition to a magenta ink.

Each of the inks included in the ink set contains a sublimable dye as a color development component. The dye contained in the magenta ink is a disperse red 146.

Even in a case where the disperse red 60 which is a coloring component of the magenta ink is replaced by the disperse red 146 among the sublimation dyes contained in the ink included in the ink set, it is possible to prevent a difference in color development and quality between before and after changing the dye.

Although the embodiment of the present disclosure has been described above, the present disclosure is not limited only to the aspects described in the embodiment. Modifications can be made as appropriate within the scope of the technical idea of the present disclosure.

What is claimed is:

1. A printing system comprising:
a printing apparatus that performs printing of information on a medium by using an ink set including at least one other ink in addition to a magenta ink;
a heat treatment apparatus that fixes the information printed on the medium by textile printing processing of the medium on which the information is printed; and
a controller, wherein
the controller includes:
a print data generation unit that generates print data from input data of information to be printed on the medium;
a print control unit that prints the information on the medium by controlling ejection of the ink onto the medium based on the generated print data; and
a textile printing parameter setting unit that sets, as a parameter of the textile printing processing, at least a heating temperature of the medium and a heating time of the medium,
each of the inks included in the ink set contains a sublimable dye as a color development component, and the dye contained in the magenta ink is a disperse red 146, and
the textile printing parameter setting unit is configured to:
set a heating temperature in the textile printing processing to a first temperature higher than a heating temperature when the dye contained in the magenta ink is a disperse red 60; and
set a heating time in the textile printing processing to a first time longer than a heating time when the dye contained in the magenta ink is a disperse red 60.

2. The printing system according to claim 1, wherein
the first temperature is a temperature that is higher by 10° C. to 40° C. than a heating temperature when the dye contained in the magenta ink is a disperse red 60, and
the first time is a time that is longer by 100 seconds at the maximum than a heating time when the dye contained in the magenta ink is a disperse red 60.

3. The printing system according to claim 2, wherein
the textile printing parameter setting unit calculates a total usage amount obtained by adding usage amounts of each of the inks included in the ink set based on the generated print data, calculates a proportion of the magenta ink to the calculated total usage amount, and sets a condition of the textile printing processing based on the calculated proportion.

4. The printing system according to claim 2, wherein
the textile printing parameter setting unit calculates an area of a region where the magenta ink is used based on the generated print data, calculates a proportion of the area of the region where the magenta ink is used to a total printing area defined by the print data, and sets a condition of the textile printing processing based on the calculated proportion.

5. The printing system according to claim 3, wherein
the controller includes a table that stores the proportion of the magenta ink and the parameter of the textile printing processing in association with each other, and
the textile printing parameter setting unit sets the first temperature and the first time by referring to the table based on the calculated proportion.

6. The printing system according to claim 5, wherein
a plurality of ink sets each of which contains different inks in addition to the magenta ink are prepared in the printing apparatus, and
a relationship between the proportion of the magenta ink and the parameter of the textile printing processing is prepared for each of the plurality of ink sets in the table.

7. The printing system according to claim 5, wherein
the controller includes a parameter presentation unit that presents at least two candidates for the parameter of the textile printing processing,
the table stores color development data in which a color development state of the medium after the textile printing processing is recorded for each parameter of the textile printing processing, and
the parameter presentation unit presents, in a case of presenting the candidates for the parameter of the textile printing processing, the color development data when the textile printing processing is performed under the presented parameter of the textile printing processing together with the candidates.

8. A method of dyeing a medium, the method comprising:
a printing step of printing information on a medium by using an ink set including at least one other ink in addition to a magenta ink; and
a heat treatment step of fixing the printed information onto the medium by textile printing processing of the medium on which the information is printed, wherein
each of the inks included in the ink set contains a sublimable dye as a color development component, and the dye contained in the magenta ink is a disperse red 146,
a heating temperature in the textile printing processing is set to a first temperature higher than a heating temperature when the dye contained in the magenta ink is a disperse red 60, and
a heating time in the textile printing processing is set to a first time longer than a heating time when the dye contained in the magenta ink is a disperse red 60.

9. The method of dyeing a medium according to claim 8, wherein
the first temperature is a temperature that is higher by 10° C. to 40° C. than a heating temperature when the dye contained in the magenta ink is a disperse red 60, and
the first time is a time that is longer by 100 seconds at the maximum than a heating time when the dye contained in the magenta ink is a disperse red 60.

10. An ink set including at least one other ink in addition to a magenta ink, wherein
each of the inks included in the ink set contains a sublimable dye as a color development component, and the dye contained in the magenta ink is a disperse red 146.
